(19) United States
(12) Patent Application Publication
(10) Pub. No.: US 2014/0234534 A1
(43) Pub. Date: Aug. 21, 2014

(54) METHOD FOR APPLYING HIGH PERFORMANCE SILICON-BASED COATING COMPOSITIONS

(71) Applicant: Christopher Fish, Central Point, OR (US)

(72) Inventor: Christopher Fish, Central Point, OR (US)

(73) Assignee: Burning Bush Technologies, LLC, Kansas City, MO (US)

(21) Appl. No.: 14/186,687

(22) Filed: Feb. 21, 2014

Related U.S. Application Data
(60) Provisional application No. 61/767,651, filed on Feb. 21, 2013.

(51) Int. Cl. C09D 183/04

(52) U.S. Cl. CPC C09D 183/04
USPC 427/58; 427/164; 427/163.1; 427/387; 15/104.93

(57) ABSTRACT

Provided herein is a method for coating a surface. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. Also provided herein is a moistened towelette for coating a surface. The towelette comprises (a) a substrate and (b) a mixture of constituents to form a silicon-based coating composition comprising silane. The mixture is contained within the substrate until applied to a surface, and, after application, the coating of the mixture onto the surface cures ambiently with or without additional heat.

### CROSS-REFERENCE

This application claims priority to U.S. Provisional Application Ser. No. 61/767,651, filed on Feb. 21, 2013, and entitled “Method for Applying High Performance Silicon-Based Coating Compositions,” which is incorporated herein by reference in its entirety.

### FIELD

The present disclosure relates to silicon-based coating compositions formed from silazane, siloxane, silane, and optionally, organic solvents and additives. The resultant composition can be used for coating a surface to form coatings having desired features including anticorrosive, antifouling, slickness, high heat transfer, high temperature, high heat resistance, and good hardness. Such coatings are useful in a wide range of applications.

### BACKGROUND

Chemical structure and conformation of the polymer are among the many factors that influence the type of coating required for a particular application. However, the commercial availability of many useful polymers often limits the applications. For example, for a long time polysilazanes have been synthesized and characterized, which acknowledges that such a polymer could be useful in a variety of applications. Currently, however, few products have been developed into a marketable commodity. Additionally, there are cost limitations that prohibit use in some cases.

There is a great need for an improved silicon-based coating for use in a wide range of applications. Such coating would be curable at ambient temperature conditions without requiring an added catalyst or activator for rapid curing, thin but durable, protective and heat-stable, displaying excellent hardness, remaining intact even when the substrate is deformed. In addition, coatings that are customizable in terms of coating color, appearance, feel, and glossiness are desirable. Further, coatings being UV-resistant, microbial releasable, easy to clean and maintain, and corrosion resistant are also in great need for their wide range of uses. Therefore, given the limitations of the prior art, it is desirable to have a coating composition that has the physical and chemical characteristics of the polymer substrates, and results in coatings possessing a number of desirable properties.

### SUMMARY

The present disclosure relates to methods for applying silicon-based coating compositions applicable to a wide range of surfaces. The composition may be formed from a mixture of constituents comprising appropriate portions of polymerized siloxane resin, polymerized silane resin, organic solvent, and optional additives. The resultant coating has thinness, durability, enhanced thermal stability, reduced coefficient of friction, greater thermal conductivity, coverage area, transparency, reparability, and ease of application. Generally, the current disclosure relates to a method for coating a surface by wiping it with a towelette containing a silicon-based coating composition.

In particular, provided herein is a method for coating a surface. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The surface may have regular contact with water, or be at or below ambient temperature. The surface may be on a transparent material, clothing, automotive part, recreational equipment, firearm, cookware, or hardware. Transparent material may be selected from the group consisting of an optic, lens, polycarbonate, glass, windshield, screen, and mirror. The clothing may be selected from the group consisting of jewelry, shoe, boot, glove, and coat. The automotive part may be selected from the group consisting of windshield, glass, leather, vinyl, wheels, windshield wiper, bumper, fiberglass, and motor, such as an outboard motor. The recreational equipment may selected from the group consisting of snow ski, snow boot, snowshoe, trek pole, wake board, water ski, surfboard, body board, boogie board, paintball gun, goggles, snowmobile, jet ski, motorcycle, dirt bike, bicycle, arrow, arrowhead, fletching, decoy, horse tack, and fishing equipment. The fishing equipment may be selected from the group consisting of fishing line, fishing guide, fishing rod, fishing reel, fly-up floatant, hard lure, hook, and soft bait. The firearm may be selected from the group consisting of handgun, rifle, gun bore, and ammunition. The cookware may be selected from the group consisting of dish, pan, pot, peeler, cutter, slicer, bowl, beater, grinder, iron, griddle, utensil, spoon, fork, knife, and grater. The hardware may be selected from the group consisting of snow shovel, rake, spade, trowel, bulb digger, faucet, nozzle, razor, scissors, clippers, pedicure instrument, manicure instrument, and comb.

In another embodiment, this disclosure provides a method for coating a surface on fishing equipment. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of a fishing line, fishing rod, fishing reel, optics, lens, windshield, windscreen, hard lure, hook, and soft bait. The cured coating may reduce friction at the surface, improve casting of the fishing equipment, reduce dirt build up, or reduce ice build up.

In yet another embodiment, this disclosure provides a method for coating a surface on a garment. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The garment may be jewelry or leather boots. The cured coating may improve the anticorrosion properties of the jewelry, or the antiallergenic and water-repellant properties of the leather boot.

In still yet another embodiment, a method for coating a surface on an automotive vehicle. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of a windshield, glass, leather, vinyl, wheels, windshield wiper, and bumper. The mixture may further comprise a conditioning agent suitable for leather or vinyl, or a polishing agent suitable for wheels. The cured coating may reduce the adhesion of insects to the bumper.

In a further embodiment, this disclosure provides a method for coating a surface on marine vehicle. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of motor, glass, ceramic, fiberglass, and poly(methylmethacrylate) (Plexiglas™). The cured coating may provide protection to the motor. The mixture may further comprise a waxing suitable for the surface.

In a yet further embodiment, this disclosure provides a method for coating a surface on recreational equipment. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of a snow ski, snow boot, snowshoe, wake board, water ski, surfboard, paintball gun, paintball goggle, snowmobile, jet ski, motorcycle, dirt bike, and bicycle. The cured coating may provide improved slickness or resistance to ice formation.

In some embodiments, this disclosure provides a method for coating a surface on a firearm. The method comprises providing a towelette moistened with a mixture of constituents to form a silicon-based coating composition comprising silane, siloxane, and an organic solvent. The mixture is transferred from the towelette to form a coating on a surface. The is cured coating ambiently with or without additional heat. The mixture may be transferred to the bore of the firearm. The cured coating may provide one or more advantages: it may reduce cleaning time of the firearm, reduce jacket and powder fouling, not alter the barrel dimensions of the firearm, not change the external appearance of the firearm, improve corrosion protection, protect the barrel of the firearm from internal wear, improve heat dissipation from the firearm, and/or reduce static electricity charges on the firearm.

In some other embodiments, this disclosure provides a method for coating a surface on ammunition, which method comprises: (a) providing a towelette moistened with a mixture of constituents to form a silicon-based coating composition comprising silane, siloxane, and an organic solvent; (b) transferring the mixture from the towelette to form a coating on a surface; and (c) curing the coating ambiently with or without additional heat. The cured coating provides improved corrosion protection, or an improved reloading efficiency of the ammunition.

In yet other embodiments, this disclosure provides a method for coating a surface on cookware. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to a dish or a pan. The cured coating may provide improved anti-sticking properties.

In another embodiment, this disclosure provides a method for coating a surface on horse tack. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may further comprise a conditioning agent suitable for leather. The cured coating provides improved corrosion protection.

In other embodiments, this disclosure provides a method for coating a surface commonly found in a house. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of snow shovel, garden tool, knife, cutlery, grater, peeler, pizza cutter, slicer, kitchen appliance, mixer bower, beater, coffee grinder, waffle iron, griddle, utensil, minor, shower, sink, and faucet. The mixture may further comprise a waxing agent suitable for use in a kitchen or a bathroom.

In still other embodiments, this disclosure provides a method for coating a surface on archery equipment. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of an arrow or a decoy. The surface of the arrow may be the arrowhead, arrow shaft, or fletching. The cured coating may improve resistance to ice build-up.

In yet other embodiments, this disclosure provides a method for coating a surface on a glove. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may further comprise a conditioning agent suitable for leather. The cured coating may provide improved gripping properties to the surface of the glove.

In still yet other embodiments, this disclosure provides a method for coating a surface on a beauty supply. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The mixture may be transferred to at least one selected from the group consisting of razor, scissor, clipper, pedicure instrument, manicure instrument, and comb. The cured coating may provide improved cutting ability to the surface. The cured coating provides improved slickness to the surface.

In further embodiments, this disclosure provides a method for coating a surface on an electronic screen. The method comprises providing a towelette moistened with a mixture of constituents to form a silicon-based coating composition comprising silane, siloxane, and an organic solvent. The mixture is transferred from the towelette to form a coating on a surface. The coating is cured ambiently with or without additional heat. The electronic screen may be on a cell phone, computer, monitor, or television. The cured coating may provide improved protection to the surface.

In another embodiment, this disclosure provides a moistened towelette for coating a surface. The towelette comprises (a) a substrate and (b) a mixture of constituents to form a silicon-based coating composition comprising silane, wherein the mixture is contained within the substrate until applied to a surface, and wherein, after application, the coating of the mixture onto the surface cures ambiently with or without additional heat. The substrate may be porous or fibrous; for example, the substrate comprises paper, cotton, or polyester. The towelette may comprise about 0.01 g to about 1 g of mixture per cm² of substrate area.

Unless otherwise defined, all technical and scientific terms used herein have the same meaning as is commonly understood by one of skill in the art to which this disclosure belongs at the time of filing. If specifically defined, then the definition provided herein takes precedent over any dictionary or extrinsic definition. Further, unless otherwise required by context, singular terms shall include pluralities, and plural terms shall include the singular. Herein, the use of “or” means “and/or” unless stated otherwise. All patents and publications referred to herein are incorporated by reference.

### DETAILED DESCRIPTION

The present disclosure relates to silicon-based coating compositions formed from certain silicon-based polymers to make extreme coatings with desirable properties including ultra thin, long lasting, non-transferable, high temperature and pressure resistance. As such, the top coatings provided by these compositions are clear, thin, hard, slick, having shortened curing processes, and with resistance or high endurance to adverse conditions including, but not limited to, drag, pull, scrub, friction, heat, moisture, high temperature, low temperature, microbial growth, corrosion, and the like. The compositions comprise polymerized silane and either or both of polymerized silazane and siloxane, and may further comprise one or more non-reactive organic solvents, and/or one or more additives for curing or for finishing, each of which in a proportion as designed herein to achieve certain properties.

In particular, providing the coating mixture on a towelette allows easy, user-friendly application without special training. The coating solution may be applied to any surface where slickness is desired, thereby extending usable life, increasing chemical resistant, reducing ice formation, increasing hydro- and aerodynamic performance.

### (I) Silicon-Based Coating Compositions

The coating mixture may be applied to a surface on, for example clothing, automotive part, recreational equipment, firearm equipment, cookware, or hardware. On fishing equipment, the surface may be on a fishing line, fishing guide, fishing rod, fishing reel, an optic used in fishing, a fly-up floatant, hard lure, hook, or soft bait. The optic may be a lens, shield or screen, and may comprise any suitably transparent material, such as Lexan™ (polycarbonate thermoplastic) or glass. The surface may be on a garment, such as clothing, jewelry, or accessories. The surface may be on an automotive vehicle, such as a windshield, glass, leather, vinyl, wheels, windshield wiper, or bumper. The surface may be on a marine vehicle, such as a motor, ceramic, fiberglass, glass, or poly(methylmethacrylate) (Plexiglas™) surface. The surface may be on recreational equipment, such as snow skis, snow boots, snowshoes, wake boards, water skis, surfboards, paintball guns, paintball goggles, snowmobile, jet skis, motocycles, dirt bikes, or bicycles. The surface may be on part of a firearm such as a handgun or rifle, or the bore or the barrel of a gun. The surface may be on ammunition. The surface may be on bakeware or cookware, such as a glass dish or a metal pan. The surface may be on horse tack. The surface may be somewhere around the house, for example, on a snow shovel, garden tool, knife, cutlery, grater, peeler, pizza cutter, slicer, kitchen appliance, mixer bowl, beater, coffee grinder, waffle iron, griddle, utensils, minor, shower, sink, or faucet. The surface may be on archery equipment such as an arrow, arrowhead, arrow shaft, fletching, or decoy. The surface may be on gloves. The surface may be on beauty supplies, such as razors, scissors, slippers, pedicure instruments, manicure instruments, or combs. The surface may also be on an electron screen, for example, the screen of a computer, cell phone, monitor, or television.

(a) Silazane

The silicon-based coating compositions of the present disclosure include polymerized silazane. “Silazane” and “polysilazane”, as appearing in the specification and claims are generic terms intended to include compounds which contain one or more silicon-nitrogen bonds in which the nitrogen atom is bonded to at least two silicon atoms, and may or may not contain cyclic units. Therefore, the terms “polysilazane” and “silazane polymer” include monomers, oligomers, cyclic, polycyclic, linear polymers or resinous polymers having at least one Si—N group in the compound, or having repeating units of H₂Si—NH, that is, [H₂Si—NH]ₙ, with “n” greater than 1. The chemical structure for polysilazane is shown below.

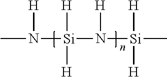

By “oligomer” is meant any molecule or chemical compound which comprises several repeat units, generally from about 2 to 10 repeat units. A simple example of silazane oligomer is disilazane H₃Si—NH—SiH₃. “Polymer”, as used herein, means a molecule or compound which comprises a large number of repeat units, generally greater than about 10 repeat units. The oligomeric or polymeric silazanes may be amorphous or crystalline in nature. Polysilazane or a mixture of polysilazanes known in the art or commercially available include such products generally known among persons skilled in the art as: silazanes, disilazanes, polysilazanes, ureasilazanes, polyureasilazanes, aminosilanes, organosilazanes, organopolysilazanes, inorganic polysilazanes, and others employing liquid anhydrous ammonia in their production. One group of polysilazane, [R₁R₂Si—NH]ₙ, is isoelectronic with and close relatives to polysiloxane [R₁R₂Si—O]ₙ. A polysilazane with the general formula (CH₃)₃Si—NH—[(CH₃)₂Si—NH]ₙ—Si(CH₃)₃ is designated as polydimethylsilazane.

The making of polysilazane using ammonolysis procedure was disclosed in U.S. Pat. No. 6,329,487. In addition, polysilazane is also commercially available. For example, polysilazane (>99%) in tert-butyl acetate solvent manufactured by KiON Defense Technologies, Inc. (Huntingdon Valley, Pa.) as KDT Ambient Cure Coating Resin (KDT HTA® 1500) is supplied as a 100% solids liquid of low viscosity. KDT HTA® 1500 may comprise less than 5% cyclosilazane, a cyclic form of polysilazane. Similar product may also beavailable from other manufacturers including AZ Electric.

Polysilazane may comprise between about 0% and about 80% (w/w) of the total formula weight of silicon-based coating compositions. In one embodiment, the silicon-based coating composition does not contain polysilazane. In some embodiments, polysilazane may comprise about 55%, 50%, 45%, 40%, 35%, 30%, 25%, 20%, 15%, 10%, 5%, 4%, 3%, 2%, 1%, 0% (w/w), or any range thereof, of the silicon-based coating composition. For example, the amount of polysilazane present in the silicon-based coating composition may range from between about 5% to about 10%, between about 8% to about 30%, between about 25% to about 40%, between about 35% to about 55%, (w/w) of the total composition, and preferably ranges from between about 5% to about 7%, between about 7% to about 9%, between about 18% to about 20%, between about 34% to about 37%, between about 38% to about 42%, between about 45% to about 55%, (w/w) of the total composition. In an exemplary embodiment, the amount of polysilazane present in the composition may be about 6% (w/w) of the total composition. In another exemplary embodiment, the amount of polysilazane present in the composition may e about 8% (w/w) of the total composition. In another exemplary embodiment, the amount of polysilazane present in the composition may be about 19% (w/w) of the total composition. In yet another exemplary embodiment present in the composition may be about 28% (w/w) of the total composition. In still another exemplary embodiment, the amount of polysilazane present in the composition may be about 36% (w/w) of the total composition. In yet another exemplary embodiment, the amount of polysilazane present in the composition may be about 40% (w/w) of the total composition. In still another exemplary embodiment, the amount of polysilazane present in the composition may be about 50% (w/w) of the total composition.

(b) Siloxane

The silicon-based coating compositions of the present disclosure also include polymerized siloxane. A siloxane is a chemical compound having branched or unbranched backbones consisting of alternating silicon and oxygen atoms —Si—O—Si—O— with side chains R attached to the silicon atoms (R₁R₂SiO), where R is a hydrogen atom or a hydrocarbon group. Polymerized siloxanes, including oligomeric and polymeric siloxane units, with organic side chains (R≠H) are commonly known as polysiloxanes, or [SiOR₁R₂]ₙ, with “n” greater than 1. The chemical structure for polysiloxanes is shown below.

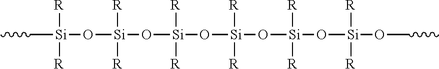

In addition to hydrogen, R₁ and R₂ of polysiloxane are independently selected from the group consisting of an alkyl, an alkenyl, a cycloalkyl, an alkylamino, aryl, aralkyl, or alkylsilyl. Thus, R₁ and R₂ can be such groups as methyl, ethyl, propyl, butyl, octyl, decyl, vinyl, allyl, butenyl, octenyl, decenyl, tetradecyl, hexadecyl, eicosyl, tetracosyl, cyclohexyl, methylcyclohexyl, methylamino, ethylamino, phenyl, tolyl, xylyl, naphthyl, benzyl, methylsilyl, ethylsilyl, propylsilyl, butylsilyl, octylsilyl, or decylsilyl. These alkyl, alkenyl, cycloalkyl, aryl, alkyl amino, aralkyl and alkylsilyl groups may each optionally be substituted by one or more substituents which contain heteroatoms, such as halides, like chlorine, bromine and iodine; alkoxy groups, like ethoxy, and also aryl groups, such as acetyl and propionyl. Organic side groups can be used to link two or more of these —Si—O— backbones together. By varying the —Si—O— chain lengths, side groups, and crosslinking, polysiloxanes can vary in consistency from liquid to gel to rubber to hard plastic. http://en.wikipedia.org/wiki/Siloxane—cite_note-1#cite_note-1 Representative examples of polysiloxane are [SiO(CH₃)₂]ₙ (polydimethylsiloxane, PDMS) and [SiO(C₆H₅)₂]ₙ (polydiphenylsiloxane). In a preferred embodiment, the silicon-based coating composition comprises polydimethylsiloxane. The chemical structure for polydimethylsiloxane is shown below.

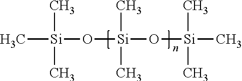

Octamethyltrisiloxane, [(CH₃)₃SiO]₂Si(CH₃)₂, is a linear siloxane in the polydimethylsiloxane family, with the INCI name as Trisiloxane. The chemical structure for Octamethyltrisiloxane is shown below.

Other methylated siloxanes include, but are not limited to: hexamethyldisiloxane, cyclotetrasiloxane, octamethylcyclotetrasiloxane, decamethyltetra-siloxane, decamethylcyclopentasiloxane. The method of producing high molecular weight polysiloxane product was disclosed in US. App. Pub. 2009/0253884. In addition, polysiloxane is also commercially available. As one example, polysiloxane, specifically, polydimethylsiloxane, is supplied in isopropyl acetate solvent by Genesee Polymers Corp. (Burton, Mich.), and it is sold as Dimethyl Silicone Fluids G-10 product. Polysiloxane as provided in the form of Dimethyl Silicone Fluids resin (e.g., B-Resin, as designated herein) comprises between about 0% and about 30% (w/w) of the total formula weight of silicon-based coating compositions. In one embodiment, the silicon-based coating composition does not contain polysiloxane in the form of Dimethyl Silicone Fluids. In some embodiments, polysiloxane may comprise about 55%, 50%, 45% 40%, 35%, 30%, 27%, 25%, 23%, 20%, 17%, 15%, 13%, 10%, 7%, 5%, 4%, 3%, 2%, 1% (w/w), or any range thereof, of the silicon-based coating composition. For example, the amount of polysiloxane present in the silicon-based coating composition may range from between about 5% to about 10%, between about 8% to about 22%, between about 20% to about 30%, between about 28% to about 40%, between about 38% to about 50% (w/w), between about 48% to about 55%, such as between about 7% to about 9%, between about 12% to about 20%, between about 22% to about 28%, between about 32% to about 38%, between about 42% to about 48%, between about 45% to about 55% (w/w) of the total composition. In an exemplary embodiment, the amount of polysiloxane present in the composition may be about 8% (w/w) of the total composition. In another exemplary embodiment, the amount of polysiloxane present in the composition may be about 15% (w/w) of the total composition. In another exemplary embodiment, the amount of polysiloxane present in the composition may be about 25% (w/w) of the total composition. In still another exemplary embodiment, the amount of polysiloxane present in the composition may be about 35% (w/w) of the total composition. In still another exemplary embodiment, the amount of polysiloxane present in the composition may be about 45% (w/w) of the total composition. In yet another exemplary embodiment, the amount of polysiloxane present in the composition may be about 50% (w/w) of the total composition.

(c) Silane

The silicon-based coating compositions of the present disclosure may further include polymerized silane. Silanes are compounds, which contain one or more silicon-silicon bonds. Polysilanes [R₁R₂Si—R₁R₂Si]ₙ are a large family of inorganic polymers. The number of repeating units, “n”, plays a role in determining the molecular weight and viscosity of the composition. Like in polysiloxane, R₁ and R₂ are independently selected from the group consisting of a hydrogen, an alkyl, an alkenyl, a cycloalkyl, an alkylamino, aryl, aralkyl, or alkylsilyl. Thus, R₁ and R₂ can be such groups as methyl, ethyl, propyl, butyl, octyl, decyl, vinyl, allyl, butenyl, octenyl, decenyl, tetradecyl, hexadecyl, eicosyl, tetracosyl, cyclohexyl, methylcyclohexyl, methylamino, ethylamino, phenyl, tolyl, xylyl, naphthyl, benzyl, methylsilyl, ethylsilyl, propylsilyl, butylsilyl, octylsilyl, or decylsilyl. A polymer with the general formula —[(CH₃)₂Si—(CH₃)₂Si]—ₙ, is designated as polydimethylsilane. The chemical structure of polydimethylsilane is shown below.

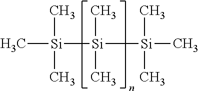

High molecular weight polysilane product with a narrow molecular weight distribution may be obtained by the process of U.S. Pat. No. 5,599,892. Polysilane is also available as a resin system supplied in amyl acetate blend from Kadko, Inc. (Beech Grove, Ind.), and it is sold as a KADKLAD R2X3™ product. Polysilane (e.g., C-Resin, as designated herein) may comprise between about 8% and about 80% (w/w) of the total formula weight of silicon-based coating compositions. In one embodiment, the silicon-based coating composition does not contain polysilane. In some embodiments, polysilane may comprise about 80%, 75%, 70%, 65%, 60%, 55%, 50%, 45%, 40%, 35%, 30%, 27%, 25%, 23%, 20%, 17%, 15%, 13%, 10%, 7%, 5%, 4%, 3%, 2%, 1% (w/w), or any range thereof, of the silicon-based coating composition. For example, the amount of polysilane present in the silicon-based coating composition may range from between about 60% to about 80%, between about 50% to about 65%, between about 30% to about 55%, between about 15% to about 35%, between about 8% to about 20%, (w/w), such as between about 65% to about 78%, between about 60% to about 75%, between about 25% to about 32%, between about 22% to about 28%, between about 8% to about 12%, (w/w) of the total composition. In an exemplary embodiment, the amount of polysilane present in the composition may be about 73% (w/w) of the total composition. In another exemplary embodiment, the amount of polysilane present in the composition may be about 67% (w/w) of the total composition. In another exemplary embodiment, the amount of polysilane present in the composition may be about 50% (w/w) of the total composition. In another exemplary embodiment, the amount of polysilane present in the composition may be about 28% (w/w) of the total composition. In yet another exemplary embodiment, the amount of polysilane present in the composition may be about 25% (w/w) of the total composition. In yet another exemplary embodiment, the amount of polysilane present in the composition may be about 17% (w/w) of the total composition. In still another exemplary embodiment, the amount of polysilane present in the composition may be about 10% (w/w) of the total composition.

(d) Solvent

The silicon-based coating compositions of the current disclosure may additionally include one or more organic solvents. Generally, the organic solvent is defined as a carbon-containing chemical that is capable of dissolving a solid, liquid, or a gas. Although one skilled in the art will appreciate that a wide variety of solvents may be incorporated into the current disclosure, suitable solvents for the present disclosure are those that contain no water and no reactive groups such as hydroxyl or amine groups. These solvents include, but not limited to, for example, aromatic hydrocarbons; aliphatic hydrocarbons, such as, hexane, heptane, benzene, toluene, branched-chain alkanes (isoparaffins); halogenated hydrocarbons; esters, such as methyl acetate, n-butyl acetate, tert-butyl acetate, isobutyl acetate, sec-butyl acetate, ethyl acetate, amyl acetate, pentyl acetate, 2-methyl butyl acetate, isoamyl acetate, n-propyl acetate, isopropyl acetate, ethylhexyl acetate; ketones, such as acetone or methyl ethyl ketone; ethers, such as tetrahydrofuran, dibutyl ether; and mono- and polyalkylene glycol dialkyl ethers (glymes) or mixtures of these solvents may be used. In a preferred embodiment, the organic solvent comprises n-butyl acetate. In another preferred embodiment, the organic solvent comprises tert-butyl acetate. In yet another preferred embodiment, the organic solvent comprises isoparaffins.

In addition, the organic solvent generally comprises between about 0% to about 70% (w/w) of the silicon-based coating composition. In some embodiments, the organic solvent comprises about 70%, about 65%, about 60%, about 55%, about 50%, about 45%, about 40%, about 35%, about 30%, about 25%, about 20%, about 15%, about 10%, about 5%, or about 0% (w/w) of the total composition. For example, the amount of organic solvent present in the silicon-based coating composition preferably ranges from between about 0% to about 35% (w/w) of the composition. In another embodiment, the amount of organic solvent in the silicon-based coating composition ranges from between about 10% to about 45% (w/w) of the total composition. In another embodiment, the amount of organic solvent in the silicon-based coating composition ranges from between about 10% to about 35% (w/w) of the total composition. In an additional embodiment, the amount of organic solvent in the silicon-based coating composition ranges from between about 20% to 55% (w/w) of the total composition. In still another embodiment, the amount of organic solvent in the silicon-based coating composition ranges from between about 25% to 45% (w/w).

(e) Additives

The silicon-based coating compositions of the current disclosure may further include one or more additives, including, but not limited to curing agents, matting agents, pigments, fillers, flow control agents, dry flow additives, anti-cratering agents, surfactants, texturing agents, light stabilizers, matting agents, photosensitizers, wetting agents, anti-oxidants, plasticizers, opacifiers, stabilizers, degassing agents, corrosion inhibitors, ceramic microspheres, slip agents, dispersing agents, mica pigments, and surface altering additives.

Among various coating composition additives that may be optionally added, substances or mixtures of substances added to a polymer composition to promote or control the curing reaction are curing agents, which include catalyst and hardener. An agent, which does not enter into the reaction, is known as a catalytic hardener or catalyst. A reactive curing agent or hardener is generally used in much greater amounts than a catalyst, and actually enters into the reaction. Curing catalyst increases the rate of a chemical reaction as an initiator. It is added in a small quantity as compared to the amounts of primary reactants, and does not become a component part of the chain. Curing hardener, often an amine, enables the formation of a complex three-dimensional molecular structure by chemical reaction between the polymers and the amine. It is essential that the correct mix ratio is obtained between resin and hardener to ensure that a complete reaction takes place, such that no unreacted resin or hardener will remain within the matrix to affect the final properties after cure. Conventional polyamine hardeners comprise primary or secondary amine groups. A polysilazane-modified polyamine hardener was described in U.S. Pat. No. 6,756,469, providing heated polyamine in the presence of a polysilazane to prepare a hardener imparting enhanced high temperature properties, higher char yields and better adhesion properties. In some embodiments, neither catalyst nor hardener is needed for a curing process that is initiated via solvent condensation. In some embodiments, each polymer in the composition can cure independently of the other without the need of forming co-polymers.

The matting agents used in the practice of this disclosure typically can alter the surface of a coating in such a way that the light falling on it is scattered in a defined fashion. The matting agent particles stand out from the coating, invisible to the human eye. The color of the coating is not affected to any great extent. Representative examples of such matting agents include inorganic matting agents such as silica-based ACEMATT® matting agents from Evonik Degussa (Parsippany, N.J.) and silica-based matting agents available from Ineos Silicas (Hampshire, United Kingdom). The matting agents may vary in size and include materials that are micron sized particles. For example, the particles may have an average diameter of from about 0.1 to 1000 microns, and in one embodiment from 0.1 to 100 microns. Combinations of matting agents may be used.

In addition, the coating composition additives typically comprise less than about 30% of the total silicon-based coating composition. In some embodiments, the additive comprises about 30%, about 25%, about 20%, about 15%, about 10%, about 9%, about 8%, about 7%, about 6%, about 5%, about 4%, about 3%, about 2%, about 1%, about 0.1%, or about 0% (w/w) of the total composition.

### (II) Application of a Coating Composition to a Surface

The coating composition may be applied by dipping, spraying, brushing, painting, wiping, immersion, or spin-coating techniques. In particular, the coating composition is provided on a towelette, which is used to apply the composition to a surface via wiping. These procedures will typically provide polymer coatings of thicknesses on the order of 1 micron or even thinner, to up to about 75 micron (or micrometers, μm) per coat for the cured polymers. If a thicker coating is desired, multiple coating layers may be provided. The coating compositions as provided herein result in a coating transparent and therefore do not affect the optical appearance of the substrate. Due to the small coating thickness, only a very small amount of material is required, which is advantageous both in terms of cost and also ecologically, and the weight change of the substrate to be coated is nearly unnoticeable. The coat thickness of the silicon-based coating as provided herein following evaporation of the solvent and curing is in the range from about 0.1 to about 50 microns, from about 0.5 to about 40 microns, from about 1 to about 25 microns, or about 12 microns. The coating as provided herein can be re-applied onto itself for touch up, repeated application over time, or after mold repairs.

Curing is the process of polymerization after the coating is applied. Curing process can be controlled through temperature, air flow, ratio of the solvents, choice of resin and hardener compounds, and the ratio of said compounds. The curing process can take minutes to hours. Some formulations benefit from heating during the cure period, whereas others simply cure at ambient temperatures over time. Coatings may be ambiently cured at room temperature ranging from 5-40° C. By providing slight amount of heat the curing time can be shortened. Curing may be performed at temperatures not exceeding about 100° C. These curing atmospheres include, but are not limited to, air and other non-reactive or reactive gaseous environments which contain moisture, inert gases like nitrogen and argon, and reactive gases such as ammonia, hydrogen, carbon monoxide, and so on. Rapid cure times are achieved using this method when the applied coatings are exposed to the moisture-containing atmosphere at room temperature.

Coating-related testing provides quality control and product description based on industrial standards. Typical coating tests may include, but are not limited to, a thickness test, coefficient of friction test, hardness test, scratch resistance test, testing the amount of force needed to scratch the coating from substrate; 90 degree peel from topcoat test; 90 degree peel from adhesive test; cross-hatch adhesion test; UV endurance test; heat stability test; conical bend test, impact direct test, and impact indirect test. In particular, thickness test, measuring the thickness of substrates and top-coated materials, may be carried out using test panels on which uniform films are produced by a coating suitable for spraying; using micrometers for dried films; using magnetic gauges for nonmagnetic coatings; using Wet Film Thickness Gauge or Pfund Gauge for wet film thickness; or using microscopic observation of precision angular cuts in the coating film. The hardness test of organic materials may be carried out using indentation hardness measurements, Sward-type hardness rocker instruments, or pendulum damping testers. In addition, the “kinetic coefficient of friction” (COF, μ), also known as a “frictional coefficient” or “friction coefficient”, describes the ratio of the force of friction between two bodies and the force pressing them together. Coefficients of friction range from near zero to greater than one. Rougher surfaces tend to have higher effective values. The COF measured under ASTM D1894 is called Standard COF. More standard ASTM (American Society for Testing and Materials) test methods for coatings are available at http://www.wernerblank.com/polyur/testmethods/coating_test.htm. In one embodiment, the thickness of the coating resulting from a silicon-based composition from about 1 micron to about 45 microns. In one embodiment, the hardness of the silicon-based coating resulted from the compositions provided herein ranges from about 4H to about 9H, using ASTM D3363. Further, in one embodiment, the COF of the silicon-based coating resulted from the compositions provided herein is between from about 0.03 to about 0.04.

Surfaces suitable for coating compositions provided herein may comprise any desirable substantially solid material that vary widely. For example, the type of surfaces that can be treated with the compositions of this disclosure includes glass; fiberglass; carbon fiber composites; basalt fiber composites; siloxane and ceramic fibers; ceramics, such as, silicon nitride, silicon carbide, silica, alumina, zirconia, and the like; metals, such as, for example, iron, stainless steel, galvanized steel, zinc, aluminum, nickel, copper, magnesium and alloys thereof, silver and gold and the like; plastics, such as, polymethyl methacrylate, polyurethane, polycarbonate, polyesters including polyethylene terephthalate, polyimides, polyamides, epoxy resins, ABS polymer, polyethylene, polypropylene, polyoxymethylene; porous mineral materials, such as, concrete, clay bricks, marble, basalt, asphalt, loam, terracotta; organic materials, such as wood, leather, parchment, paper and textiles; and coated surfaces, such as, plastics emulsion paints, acrylic coatings, epoxy coatings, melamine resins, polyurethane resins and alkyd coatings. The surface or substrate contemplated herein may also comprise at least two layers of materials. One layer of material, for example, may include glass, metal, ceramic, plastics, wood or composite material. Other layers of material comprising the surface or substrate may include layers of polymers, monomers, organic compounds, inorganic compounds, organometallic compounds, continuous layers, porous and nanoporous layers.

Further, the surfaces may have different shapes, e.g., substrates having flat, planar surfaces, molded articles having curved surfaces, fibers, fabrics, and the like. It will be appreciated by those skilled in the art that the foregoing lists are merely illustrative of various materials, which may be coated using the presently disclosed compositions and methods, and are not in any way limiting of the different substrates with which the present disclosure is useful. Insofar as they protect virtually any type of substrate from oxidative thermal degradation, corrosion, or chemical attack. The coatings may also be used to strengthen relatively flaw-sensitive brittle substrates such as glass and non-wetting surfaces. The coatings may additionally be useful to provide bonding or compatibility interfaces between different types of materials.

In some embodiments, the silicon-based composition may comprise about 0.1% to about 5% (w/w) silanes, about 0.1% to about 25% (w/w) siloxane, about 25% to about 75% (w/w) isopropyl acetate, and about 25% to about 75% (w/w) organic solvent. For example, the silicon-based composition may comprise about 0.4% to about 1% (w/w) silanes, about 0.4% to about 12% (w/w) siloxane, about 30% to about 55% (w/w) isopropyl acetate, and about 45% to about 55% (w/w) organic solvent. In a further example, the silicon-based composition may comprise about 0.4% to about 0.6% (w/w) silanes, about 0.4% to about 12% (w/w) siloxane, about 35% to about 50% (w/w) isopropyl acetate, and about 45% to about 55% (w/w) organic solvent. The towelette may contain about 0.1 g to about 10 g of composition, for example about 0.5 g to about 5 g of composition, about 0.5 g, about 1 g, about 1.5 g, about 2 g, about 2.5 g, about 3 g, about 3.5 g, about 4 g, about 4.5 g, or about 5 g.

Although the disclosure described herein is susceptible to various modifications and alternative iterations, specific embodiments thereof have been described in greater detail above. It should be understood, however, that the detailed description of the silicon-based composition is not intended to limit the disclosure to the specific embodiments disclosed. Rather, it should be understood that the disclosure is intended to cover all modifications, equivalents, and alternatives falling within the spirit and scope of the disclosure as defined by the claim language.

### DEFINITIONS

As used herein, the terms “about” and “approximately” designate that a value is within a statistically meaningful range. Such a range can be typically within 20%, more typically still within 10%, and even more typically within 5% of a given value or range. The allowable variation encompassed by the terms “about” and “approximately” depends on the particular system under study and can be readily appreciated by one of ordinary skill in the art.

As used herein, the term “w/w” designates the phrase “by weight” and is used to describe the concentration of a particular substance in a mixture or solution.

As used herein, the term “ml/kg” designates milliliters of composition per kilogram of formula weight.

As used herein, the term “cure” or “curing” refers to a change in state, condition, and/or structure in a material that is usually, but not necessarily, induced by at least one variable, such as time, temperature, moisture, radiation, presence and quantity in such material of a catalyst or accelerator or the like. The terms cover partial as well as complete curing

As used herein, the term “hardness” or “H” designates the property of a material that enables it to resist plastic deformation, usually by penetration. However, the term hardness may also refer to resistance to bending, scratching, abrasion or cutting. The usual method to achieve a hardness value is to measure the depth or area of an indentation left by an indenter of a specific shape, with a specific force applied for a specific time. There are four principal standard test methods for expressing the relationship between hardness and the size of the impression, these being Pencil Hardness ASTM D3363, Brinell, Vickers, and Rockwell. For practical and calibration reasons, each of these methods is divided into a range of scales, defined by a combination of applied load and indenter geometry.

As used herein, the term “coefficient of friction” (COF), also known as a “frictional coefficient,” “friction coefficient,” or “kinetic coefficient of friction,” is an empirical measurement which describes the ratio of the force of friction between two bodies and the force pressing them together. The coefficient of friction depends on the materials used. When the coefficient of friction is measured by a standardized surface, the measurement is called “standardized coefficient of friction.”

As used herein, the term “corrosion resistant agent” or variation thereof refers to additives in the coating on a surface, which inhibit the corrosion of the surface substrate when it is exposed to air, heat, or corrosive environments for prolonged time periods.

“Conditioning agent” refers to a substance used to improve or maintain the condition of a material, for example the condition of a leather or vinyl surface. A conditioning agent may include, but is not limited to, dubbin, tallow, lanolin; a wax, such as beeswax, cera alba, and copernica cerifera cera; an oil, such as olive oil, codliver oil, mink oil, and neatsfoot oil (rendered pig fat); glycerin, polyethylene, diethylhexyl sodium sulfosuccinate, poly(acrylic acid), carbomer, and tetraethylammonium dodecylbenzenesulfonate. Optionally, the conditioning agent may comprise a UV-protective agent.

“Polishing agent” refers to a substance used to remove contamination or tarnish from a surface, for example from an automotive body, glass, or mirrors. A polishing agent may include, but is not limited to, an abrasive, such as silica, lithium magnesium sodium silicate, alumina, or sodium bicarbonate.

“Waxing agent” refers to a substance used to impart sheen to a cleaned surface, for example to an automotive body, glass, or minors. A waxing agent may include, but is not limited to, a wax, such as copernica cerifera cera; dimethicone, alkane sulfonate, aryl glucoside, hexyldecanol, and butoxyethanol.

As used herein, the term “monomer” refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. Monomers may belong to various chemical classes of molecules including organic, organometallic or inorganic molecules. The molecular weight of monomers may vary greatly between about 40 Daltons and 20,000 Daltons. However, especially when monomers comprise repetitive building blocks, monomers may have even higher molecular weights. Monomers may also include additional reactive groups.

Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Daltons and 400,000 Daltons or more.

“Towelette” refers to a relatively small towel moistened and in a sealed package. The towelette may also be referred to as a wipe, napkin, or serviette. The towelette may be composed of cloth, paper, or other fibrous mesh, comprising natural fibers, synthetic fibers, or combinations thereof.

The following examples are intended to further illustrate and explain the present disclosure. The disclosure, therefore, should not be limited to any of the details in these examples.

### EXAMPLES

### Example 1

### Preparation of Resin Systems for Making Silicon-Based Coating Compositions

The silicon-based coating compositions provided herein were formed from two or more different resin systems chosen from, what was known as A-Resin, B-Resin, C-Resin, and any combinations thereof. The A-Resin was made according to the formulation provided in Table 1. The A-Resin was purchased from KiON Defense Technologies (Huntingdon Valley, Pa.), and it was sold as KDT HTA 1500 Fast™, an air curable liquid polysiloxazane based coating resin (8.9 lbs/Gallon).

TABLE 1
A-Resin formulation

| Ingredient | CAS NO | Amount (w/w) Appx. |
|---|---|---|
| Polysilazane | | >99% (w/w) |
| Cyclosilazane | CAS# 503590-70-3 | <5% (w/w) |
| n-Butyl Acetate | CAS# 123-86-4 (CAS# 540- | <3% (w/w) |
| (or tert-Butyl | 88-5) | |
| Acetate) | | |

The B-Resin was made according to the formulation provided in Table 2. The B-Resin was purchased from Genesee Polymers Corp. (Burton, Mich.), and it was sold as Dimethyl Silicone Fluids G-10 products (8.0 lbs/Gallon).

TABLE 2
B-Resin formulation

| Ingredient | CAS NO | Amount (w/w) Appx. |
|---|---|---|
| Polydimethylsiloxane Fluid | CAS# 63148-62-9 | <5% (w/w) |
| Isopropyl Acetate Solvent | CAS# 108-24-4 | <98% (w/w) |

The C-Resin was made according to the formulation provided in Table 3. The C-Resins was purchased from Kadko, Inc. (Beech Grove, Ind.), and it was sold as a polysilazane based KADKLAD R2X3™ product. KADKALD R2X3™ may also be prepared using KADKLAD™ FRP concentrate at a 1 volume % or 1 weight % to the Isopar™ E solvent (C₇₋₁₀ alkanes). Using the concentrate permits lower costs and greater formula flexibility. The ratio of KADKLAD R2X3™ to solvent may vary depending on the end use, for example from about 1% to about 20% by volume of the composition.

TABLE 3
C-Resin formulation

| | | | Amount (w/w) |
|---|---|---|---|
| Ingredient | CAS NO | | Appx. |
| Polysilane | | | <8% (w/w) |
| Amyl Acetate Blend | CAS# 628-63-7 | | <98% |
| Isopropyl Acetate | CAS# 108-21-4 | 25-35% | |
| Isoparaffnic | CAS# 64741-66-8 | 50-60% | |
| Hydrocarbon | | | |
| Aliphatic | CAS# 64742-47-8 | 5-10% | |
| Hydrocarbon | | | |
| Acetate Ester | CAS# 108419-34-7 | 1-5% | |

The A-, B-, and C-Resin systems were then used in appropriate amount for different formulations, as such a mix of polysilazane, polysiloxane and/or polysilane and acetate solvent was used to produce formulations of coating products with various desired properties as described below.

Characteristics of the coating products using the formulations provided herein included extreme release, long lasting, non-transferable, clear, thin, light, slick, hard, high pressure resistant, high temperature resistant, chemical resistant, and microbial resistant.

### Example 2

### Preparation of Resin Systems for Use in Towelettes

To form a coating solution according to this disclosure, two solutions are prepared, Mixture A and Mixture B. Components for each Mixture are blended together with agitation. Bulk preparation of the Mixtures allows for fast production and good inventory control. The Mixtures may be combined in ratios of from about 1:99 to about 99:1, or about 1:1. Particular Mixtures and ratios are exemplified in Table 4.

TABLE 4
Coating formulations

| | | |
|---|---|---|
| Mixture A | Mixture B | Ratio of |

| | Kladko ™ | Isopar ™ | Dimethyl | Isopropyl | Mixtures |
|---|---|---|---|---|---|
| Formulation | FRP resin | E | fluid | acetate | A:B |
| DT 60 | 1% | 99% | 1% | 99% | 1:1 |
| DT 61 | 1% | 99% | 4% | 96% | 1:1 |
| DT 62 | 1% | 99% | 6% | 94% | 1:1 |
| DT 64 | 1% | 99% | 24% | 76% | 1:1 |

| | | | | |
|---|---|---|---|---|
| DT 65+ | 1% | 99% | Racers edge #3 | 1:3 |

Each formulation in Table 4 may be particularly suited to a specific application. For example, DT 65+ is particularly beneficial for coating surfaces of an automobile. For formulation DT 65+, three parts of Racers Edge™ #3 polish are mixed with 1 part Mixture A, which contains 1% (v/v) Kladko™ FRP resin to 99% (v/v) Isopar™ E. Racers Edge™ #3 polish is a blend of two pharmaceutical grade polymers, and a UV50 sunscreen to provide protection against the corrosive effects of acid rain, snow, wind, salt, sap, tar, bugs, bird droppings, and sunlight. One of the polymers is manufactured by TR Industries, California.

Each formulation may be applied to a towelette and stored in a moisture-tight container until application to the desired surface.

Table 5 compares the performance of polysilane/polysiloxane coatings prepared according to the present disclosure with conventional polytetrafluoroethylene (PTFE, Teflon™) coatings.

TABLE 5
Comparison of conventional PTFE coatings to polysilane/polysiloxane coatings

| Conventional PTFE Coatings | Polysilazane/Polysiloxane Coatings |
|---|---|
| Fluoropolymer-based chemistry | Nanoceramic technology |
| Adds about 12-50 microns of coating | Adds about 2-4 microns of coating thickness |
| thickness (0.5-2 mils) | (up to about 0.5 mils) |
| Requires mechanical etch to the substrate | Requires clean substrate or mechanical etch |
| Suitable for use on metals and some glass | Suitable for use on any surface, including |
| | silicones |
| Passes 3/16 mandrel bend test at 50 microns | Comparable. Can be applied to foil or film |
| | surfaces without loss of adhesion from |
| | crushing or flexing |
| Cures at 288-454° C. (550-850° F.) | Cures at ambient temperature. Performance |
| | increases with heated cure. |
| VOCs vary with formulation | VOC compliant/exempt |
| | (per 40 C.F.R. § 51.100) |
| Deteriorates at about 260° C. (500° F.) and | No deterioration up to 982° C. (1800° F.), |
| decomposes above 350° C. (662° F.) | depending on the formulation and surface |
| | preparation. Pyrolysis does not occur at this |
| | temperature. |
| Coefficient of friction is 0.05-0.10μ | Coefficient of friction is 0.03-1.5μ |
| (per formula) | (per formulation) |
| Food grade versions | Food grade approvable |
| Applied conventionally or by electrospray | Applied by spray, wipe-on, or dip procedures. |
| Black- or gray-colored | Clear and transparent |
| Covers up 20.4 m² (220 sq. ft.) per gallon, | Coverage rate of greater than 116 m² (1250 sq. |
| depending on formula and assuming 100% | ft.) per gallon at a thickness of 12 microns, |
| efficiency | depending on formula and assuming 100% |
| | efficiency |
| Cost per square foot at $175/gallon is $0.97/sq. | Cost per square foot at $330/gallon is |
| ft. | $0.265/sq. ft. |
| Corrosion protection is good to excellent at 50 | Corrosion protection is good to excellent at 12 |
| microns (2 mils) | microns (0.5 mils) |
| Not recoatable once fully cured. To recoat, the | Recoatable as long as surface is properly |
| surface must be blasted to bare metal. | prepared. Will also adhere to a clean PTFE |
| | coating. |
| Not repairable | Repairable |
| Hardness of 2-7 H, depending on the formula | Hardness of 5-9 H at 12-microns thick, |
| | depending on the formula |
| Thermal conductivity is 1.70 BTU-in/ft²-hr-° F. | Thermal conductivity is 6.8 BTU-in/ft²-hr-° F. |
| at a thickness of 50 microns (2 mils) | at a thickness of 12 microns (0.5 mils). Heat is |
| | also more uniformly distributed across the |
| | substrate. |

As can be seen in Table 5, silicon-based coatings of the present disclosure outperform conventional PTFE coatings in a number of characteristics, including the thinness of durable coats, enhanced thermal stability, reduced coefficient of friction, greater thermal conductivity, improved coverage area, transparency, reparability, and ease of application. Because substrates need only be clean, they do not have to be mechanically etched before application or reapplication. The polysilane/polysiloxane coatings also offer an alternative for repairing damaged PTFE. Instead of mechanically etching a damaged PTFE coating, compositions of the present disclosure may be applied to a properly cleaned PTFE to restore its non-stick, anticorrosive, and other desirable characteristics.

What is claimed is:

1. A method for coating a surface, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

2. The method of claim 1, wherein the surface has regular contact with water.

3. The method of claim 1, wherein the surface is at or below ambient temperature.

4. The method of claim 2, wherein the surface is on a transparent material, clothing, automotive part, recreational equipment, firearm, cookware, or hardware.

5. The method of claim 4, wherein the transparent material is selected from the group consisting of an optic, lens, polycarbonate, glass, windshield, screen, and minor.

6. The method of claim 4, wherein the clothing is selected from the group consisting of jewelry, shoe, boot, glove, and coat.

7. The method of claim 4, wherein the automotive part is selected from the group consisting of windshield, glass, leather, vinyl, wheels, windshield wiper, bumper, fiberglass, and motor.

8. The method of claim 7, wherein the motor is an outboard motor.

9. The method of claim 4, wherein the recreational equipment is selected from the group consisting of snow ski, snow boot, snowshoe, trek pole, wake board, water ski, surfboard, body board, boogie board, paintball gun, goggles, snowmobile, jet ski, motorcycle, dirt bike, bicycle, arrow, arrowhead, fletching, decoy, horse tack, and fishing equipment.

10. The method of claim 9, wherein the fishing equipment is selected from the group consisting of fishing line, fishing guide, fishing rod, fishing reel, fly-up floatant, hard lure, hook, and soft bait.

11. The method of claim 4, wherein the firearm is selected from the group consisting of handgun, rifle, gun bore, and ammunition.

12. The method of claim 4, wherein the cookware is selected from the group consisting of dish, pan, pot, peeler, cutter, slicer, bowl, beater, grinder, iron, griddle, utensil, spoon, fork, knife, and grater.

13. The method of claim 4, wherein the hardware is selected from the group consisting of snow shovel, rake, spade, trowel, bulb digger, faucet, nozzle, razor, scissors, clippers, pedicure instrument, manicure instrument, and comb.

14. A method for coating a surface on fishing equipment, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

15. The method of claim 14, wherein the mixture is transferred to at least one selected from the group consisting of a fishing line, fishing rod, fishing reel, optics, lens, windshield, windscreen, hard lure, hook, and soft bait.

16. The method of claim 15, wherein the cured coating reduces friction at the surface, improves casting of the fishing equipment, reduces dirt build up, or reduces ice build up.

17. A method for coating a surface on a garment, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

18. The method of claim 17, wherein the garment is jewelry or leather boots.

19. The method of claim 18, wherein the cured coating improves the anticorrosion properties of the jewelry.

20. The method of claim 18, wherein the cured coating improved the antiallergenic and water-repellant properties of the leather boot.

21. A method for coating a surface on an automotive vehicle, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

22. The method of claim 21, wherein the mixture is transferred to at least one selected from the group consisting of a windshield, glass, leather, vinyl, wheels, windshield wiper, and bumper.

23. The method of claim 21, wherein the mixture further comprises a conditioning agent suitable for leather or vinyl.

24. The method of claim 21, wherein the mixture further comprises a polishing agent suitable for wheels.

25. The method of claim 22, wherein the cured coating reduces the adhesion of insects to the bumper.

26. A method for coating a surface on marine vehicle, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

27. The method of claim 26, wherein the mixture is transferred to at least one selected from the group consisting of motor, glass, ceramic, fiberglass, and poly(methylmethacrylate).

28. The method of claim 27, wherein the cured coating provides protection to the motor.

29. The method of claim 28, wherein the mixture further comprises a waxing suitable for the surface.

30. A method for coating a surface on recreational equipment, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

31. The method of claim 30, wherein the mixture is transferred to at least one selected from the group consisting of a snow ski, snow boot, snowshoe, wake board, water ski, surfboard, paintball gun, paintball goggle, snowmobile, jet ski, motorcycle, dirt bike, and bicycle.

32. The method of claim 31, wherein the cured coating provides improved slickness or resistance to ice formation.

33. A method for coating a surface on a firearm, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

34. The method of claim 33, wherein the mixture is transferred to the bore of the firearm.

35. The method of claim 33, wherein the cured coating reduces cleaning time of the firearm.

36. The method of claim 33, wherein the cured coating reduces jacket and powder fouling.

37. The method of claim 33, wherein the cured coating does not alter the barrel dimensions of the firearm or change the external appearance of the firearm.

38. The method of claim 33, wherein the cured coating provides improved corrosion protection.

39. The method of claim 33, wherein the cured coating protects the barrel of the firearm from internal wear.

40. The method of claim 33, wherein the cured coating improves heat dissipation from the firearm.

41. The method of claim 33, wherein the cured coating reduces static electricity charges on the firearm.

42. A method for coating a surface on ammunition, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

43. The method of claim 42, wherein the cured coating provides improved corrosion protection.

44. The method of claim 43, wherein the cured coating provides improved reloading efficiency of the ammunition.

45. A method for coating a surface on cookware, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

46. The method of claim 45, wherein the mixture is transferred to a dish or a pan.

47. The method of claim 46, wherein the cured coating provides improved anti-sticking properties.

48. A method for coating a surface on horse tack, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

49. The method of claim 48, wherein the mixture further comprises a conditioning agent suitable for leather.

50. The method of claim 48, wherein the cured coating provides improved corrosion protection.

51. A method for coating a surface commonly found in a house, which method comprises:
(a) providing a towelette moistened with a mixture of constituents to form a silicon-based coating composition comprising silane, siloxane, and an organic solvent;
(b) transferring the mixture from the towelette to form a coating on a surface;
(c) curing the coating ambiently with or without additional heat.

52. The method of claim 51, where the mixture is transferred to at least one selected from the group consisting of snow shovel, garden tool, knife, cutlery, grater, peeler, pizza cutter, slicer, kitchen appliance, mixer bower, beater, coffee grinder, waffle iron, griddle, utensil, minor, shower, sink, and faucet.

53. The method of claim 52, wherein the mixture further comprises a waxing agent suitable for use in a kitchen or a bathroom.

54. A method for coating a surface on archery equipment, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

55. The method of claim 54, wherein the mixture is transferred to at least one selected from the group consisting of an arrow or a decoy.

56. The method of claim 55, wherein the surface of the arrow is the arrowhead, arrow shaft, or fletching.

57. The method of claim 55, wherein the cured coating provides improved resistance to ice build-up.

58. A method for coating a surface on a glove, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

59. The method of claim 58, wherein the mixture further comprises a conditioning agent suitable for leather.

60. The method of claim 59, wherein the cured coating provides improved gripping properties to the surface of the glove.

61. A method for coating a surface on a beauty supply, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

62. The method of claim 61, wherein the mixture is transferred to at least one selected from the group consisting of razor, scissor, clipper, pedicure instrument, manicure instrument, and comb.

63. The method of claim 62, wherein the cured coating provides improved cutting ability to the surface.

64. The method of claim 62, wherein the cured coating provides improved slickness to the surface.

65. A method for coating a surface on an electronic screen, which method comprises:
(a) providing a towelette moistened with a mixture of constituents to form a silicon-based coating composition comprising silane, siloxane, and an organic solvent;
(b) transferring the mixture from the towelette to form a coating on a surface; and
(c) curing the coating ambiently with or without additional heat.

66. The method of claim 65, wherein the electronic screen is on a cell phone, computer, monitor, or television.

67. The method of claim 66, wherein the cured coating provides improved protection to the surface.

68. The method of claim 1, wherein the mixture comprises:
0.1% to 5% (w/w) silanes,
0.1% to 25% (w/w) siloxane,
25% to 75% (w/w) isopropyl acetate, and
25% to 75% (w/w) organic solvent.

69. The method of claim 1, wherein the mixture comprises:
0.4% to 1% (w/w) silanes,
0.4% to 12% (w/w) siloxane,
30% to 55% (w/w) isopropyl acetate, and
45% to 55% (w/w) organic solvent.

70. A moistened towelette for coating a surface, which towelette comprises:
(a) a substrate;
(b) a mixture of constituents to form a silicon-based coating composition comprising silane wherein the mixture is contained within the substrate until applied to a surface, and wherein, after application, the coating of the mixture onto the surface cures ambiently with or without additional heat.

71. The moistened towelette of claim 70, wherein the substrate is porous or fibrous.

72. The moistened towelette of claim 70, wherein the substrate comprises paper, cotton, or polyester.

73. The moistened towelette of claim 70, wherein the towelette comprises about 0.01 g to about 1 g of mixture per cm² of substrate area.

74. The moistened towelette of claim 70, wherein the mixture comprises:
0.1% to 5% (w/w) silanes,
0.1% to 25% (w/w) siloxane,
25% to 75% (w/w) isopropyl acetate, and
25% to 75% (w/w) organic solvent.

75. The moistened towelette of claim 70, wherein the mixture comprises:
0.4% to 1% (w/w) silanes,
0.4% to 12% (w/w) siloxane,
30% to 55% (w/w) isopropyl acetate, and
45% to 55% (w/w) organic solvent.
